(19) United States
(12) Patent Application Publication
(10) Pub. No.: US 2008/0239568 A1
(43) Pub. Date: Oct. 2, 2008

(54) PERPENDICULAR MAGNETIC RECORDING HEAD AND MANUFACTURING METHOD THEREOF

(76) Inventors: Akira Miyatake, Niigata-ken (JP); Kiyoshi Kobayashi, Niigata-ken (JP)

Correspondence Address: BRINKS HOFER GILSON & LIONE, P.O. BOX 10395, CHICAGO, IL, 60610, US

(21) Appl. No.: 12/039,538

(22) Filed: Feb. 28, 2008

(30) Foreign Application Priority Data
Mar. 26, 2007 (JP) 2007-078171

(51) Int. Cl. G11B 5/23; B44C 1/22

(52) U.S. Cl. 360/119.03; 216/22

(57) ABSTRACT

A perpendicular magnetic recording head includes a main magnetic pole layer and a return yoke layer laminated on the main magnetic pole layer with a magnetic gap layer disposed in an opposing surface opposite a recording medium. Further included is a resist layer having a front end surface at a position retreated from the opposing surface opposite the recording medium to a deeper side in a height direction. The resist layer defines a throat height of the return yoke layer at the front end surface position. A Ti film is formed directly below the resist layer, forming at least a portion of the magnetic gap layer. The Ti film is a non-light transmitting film through which light cannot pass.

### RELATED APPLICATIONS

This application claims the benefit of priority under 35 U.S.C. §119 to Japanese Patent Application No. 2007-078171 filed Mar. 26, 2007, the contents of which are hereby incorporated by reference in their entirety.

### BACKGROUND OF THE DISCLOSURE

1. Field of the Disclosure

The present disclosure relates to a perpendicular magnetic recording head that records information by applying a perpendicular magnetic field to a recording medium and to a manufacturing method thereof.

2. Description of the Related Art

As is widely known, a perpendicular magnetic recording head has a main magnetic pole layer, a return yoke layer, a magnetic gap layer and a coil layer that induces a recording magnetic field between the main magnetic pole layer and the return path layer. The main magnetic pole layer has a front end surface exposed to an opposing surface opposite a recording medium (hereinafter this surface is referred to as “recording medium-opposing surface”). The return yoke layer also has a front end surface exposed to the recording medium-opposing surface. The main magnetic pole layer is magnetically coupled to the return yoke layer at the side remote from the recording medium-opposing surface in the height direction. The magnetic gap layer is disposed between the main magnetic pole layer and the return yoke layer. The recording magnetic field induced between the main magnetic pole layer and the return yoke layer enters a hard film of the recording medium in a perpendicular fashion from the front end surface of the main magnetic pole layer. The recording magnetic field passes through a soft film of the recording medium and returns to the front end surface of the return path layer to thereby complete magnetic recording on the recording medium in the portion that opposes the main magnetic pole layer. According to a proposal regarding a perpendicular magnetic recording head, a so-called shielded pole structure is suggested in which the spacing (a gap spacing) between the main magnetic pole layer and the return path layer in the recording medium-opposing surface is narrowed to about 50 nm so that magnetic recording that has little leakage can be realized by controlling (suppressing) divergence of a magnetic flux directed to the recording medium from the main magnetic pole layer. In a perpendicular magnetic recording head device that has the shielded pole structure, the dimension (a throat height) of the return path layer in a height direction as well as the above gap spacing becomes an important parameter for controlling a recording magnetic field (specifically, the recording magnetic field intensity and gradient). It is thus necessary to set this throat height properly.

In the past, for example, Japanese Unexamined Patent Application Publication Nos. 2001-256614, 2004-318948, 2004-318949, and 2005-149682 disclose a structure in which a resist layer is provided right below the return yoke layer at a portion located deeper than the recording medium-opposing surface in the height direction. A throat height is defined at an end surface position (front end surface position) of the resist layer close to the recording medium-opposing surface. The resist layer is composed of an organic resist material.

The main magnetic pole layer, the magnetic gap layer, a positioning layer, and the return yoke layer are formed by the following manufacturing method, for example. First, on the entire surface of a main magnetic pole layer composed of a magnetic material, a magnetic gap layer made of Al₂O₃ and a resist layer made of an organic resist material are sequentially laminated. Next, the resist layer is removed by a photolithographic process (exposure and development) so that the resist layer is removed from the end surface serving as the recording medium-opposing surface to a position where a desired throat height is obtained. The magnetic gap layer is exposed to the removed portion. Then, as plating pre-treatment, the exposed magnetic gap layer and the resist layer are subjected to an etching process. A return yoke layer is formed by plating with a magnetic material on the magnetic gap layer and the resist layer.

According to the known manufacturing method, the throat height is defined as a distance from the end surface serving as the recording medium-opposing surface to the front end surface of the resist layer. The magnetic gap layer made of Al₂O₃ is eroded by an alkali developing solution used in the photolithographic process to remove the resist layer. A desired gap spacing is not obtained. A method that solves such a problem has been proposed by the present applicant in Japanese Patent Application No. 2005-278283 (corresponding to US Patent Application Publication No. 2007-067982). According to the proposed method, a protective layer (upper gap layer) made of SiO₂ is formed on a magnetic gap layer (lower gap layer) made of Al₂O₃ as a part of the magnetic gap layer in order to prevent erosion of the upper gap layer by a developing solution.

However, when a SiO₂ film is used in the protective layer (upper gap layer), the cohesive properties of the SiO₂ film with respect to the resist layer formed on the SiO₂ film are deteriorated. As a method for improving the cohesive properties, for example, an HMDS process is known in which gaseous HMDS (hexamethyl disilazane) is caused to adhere the SiO₂ film to thereby improve the cohesive properties of the SiO₂ film with respect to the resist film by the HMDS film. However, the HMDS process is likely to form a scum on the resist layer. When a dry etching is performed to remove the scum, due to the uneven etching, the position of the front end surface of the resist layer defining the throat height fluctuates. It is thus difficult to define the throat height with high precision using the resist layer. Additionally, since the magnetic gap layer made of SiO₂ and Al₂O₃ has light transmitting properties, light passing through the magnetic gap layer formed of the SiO₂ film and the Al₂O₃ film from the resist layer is irregularly reflected from a metal film (a main magnetic pole layer, for example) formed under the SiO₂ film. The irregular reflection makes focusing difficult and thus a sufficient edge contrast difficult to obtain. For this reason, as shown in FIGS. 9C and 9D, in a patterned resist layer 118′, a rising angle θ2′ of the front end surface close to the recording medium-opposing surface is decreased by the fault in the peripheral portion. In this way, when the resist layer is not formed in a desired shape with the front end surface at a desired position, the positional precision of the throat height is deteriorated. As the rising angle θ2 (0 degrees<θ2≦90 degrees) of the front end surface of the resist layer increases, the positional precision of the front end surface is improved. The irregular reflection caused during resist exposure can be eliminated by restricting the forming position of the main magnetic pole layer, though with sacrifice of a design freedom.

### SUMMARY OF THE DISCLOSURE

The present disclosure provides a perpendicular magnetic recording head that includes a main magnetic pole layer; a return yoke layer laminated on the main magnetic pole layer with a magnetic gap layer disposed in an opposing surface opposite a recording medium; and a resist layer having a front end surface at a position retreated from the opposing surface opposite the recording medium to a deeper side in a height direction. The resist layer defines a throat height of the return yoke layer at the front end surface position. A Ti film is formed right below the resist layer, forming at least a portion of the magnetic gap layer. The Ti film is a non-light transmitting film through which light cannot pass.

in one embodiment, the magnetic gap layer may be formed by laminating a nonmagnetic material film that is not exposed to the opposing surface opposite the recording medium. On a side deeper in the height direction than the opposing surface opposite the recording medium, the nonmagnetic material layer is exposed to the Ti film disposed right below the resist layer and the opposing surface opposite the recording medium. The nonmagnetic material layer is disposed in the opposing surface opposite the recording medium between the main magnetic pole layer and the return yoke layer. The Ti film serves as a protective film of the nonmagnetic material film. In practical use, the nonmagnetic material film is formed of Al₂O₃.

The present disclosure provides a manufacturing method of a perpendicular magnetic recording head, comprising: forming a nonmagnetic material film on a main magnetic pole layer to form a portion of a magnetic gap layer; forming a Ti film on the nonmagnetic material film to form a portion of the magnetic gap layer, the Ti film being a non-light transmitting layer through which light cannot pass; forming a resist layer of an organic resist material on the entire surface of the Ti film; exposing and developing the resist layer while leaving the resist layer on the Ti film in such a pattern shape that a front end surface of the resist layer is retreated from a position serving as an opposing surface opposite a recording medium to a deeper side in the height direction by a predetermined throat height; performing a dry etching process to expose a new film surface of the resist layer while removing the Ti film not covered with the resist layer to expose the nonmagnetic material film to the removed portion; and forming a return yoke layer on the exposed, nonmagnetic material film, Ti film, and resist layer.

The present disclosure also provides a manufacturing method of a perpendicular magnetic recording head, comprising: forming a Ti film on a main magnetic pole layer to constitute a magnetic gap layer, the Ti film being a non-light transmitting film through which light cannot pass; forming a resist layer of an organic resist material on the entire surface of the Ti film; exposing and developing the resist layer while leaving the resist layer on the Ti film in such a pattern shape that a front end surface of the resist layer is retreated from a position serving as an opposing surface opposite a recording medium to a deeper side in the height direction by a predetermined throat height; performing a dry etching process to expose the resist layer and a new film surface of the Ti film not covered with the resist layer; forming a second Ti film on the entire surface of the exposed resist layer and Ti film; and forming a return yoke layer on the second Ti film by plating.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 is a partly longitudinal sectional view showing the entire structure of a perpendicular magnetic recording head according to a first embodiment of the present disclosure.

FIG. 2 is a partly enlarged sectional view showing a circumferential portion of a return yoke layer of the perpendicular magnetic recording head.

FIG. 3 is a sectional view showing one process step of a manufacturing method of a perpendicular magnetic recording head according to the present disclosure.

FIG. 4 is a sectional view showing a process step subsequent to the process step shown in FIG. 3.

FIG. 5 is a sectional view showing a process step subsequent to the process step shown in FIG. 4.

FIG. 6 is a sectional view showing a process step subsequent to the process step shown in FIG. 5.

FIG. 7 is a partly enlarged sectional view showing a circumferential portion of a return yoke layer of the perpendicular magnetic recording head, in which a magnetic gap layer is formed using a two-layered Ti film.

FIG. 8 is a partly enlarged sectional view showing a circumferential portion of a return yoke layer of the perpendicular magnetic recording head, in which a magnetic gap layer is formed using a single-layered Ti film.

FIGS. 9A and 9B are top and sectional views, respectively, schematically showing a patterned resist layer (Inventive Example) when a Ti film is formed right below the resist layer as at least a part of the magnetic gap layer.

FIGS. 9C and 9D are top and sectional views, respectively, schematically showing a patterned resist layer (Comparative Example) when a SiO₂ film is formed right below a resist layer as at least a part of the magnetic gap layer.

### DESCRIPTION OF THE EMBODIMENTS

Exemplary embodiments may be better understood with reference to the drawings, but these examples are not intended to be of a limiting nature. Like numbered elements in the same or different drawings perform equivalent functions.

The present disclosure will now be described with reference to drawings, covering various non-exhaustive embodiments. In each of the drawings, the X direction is the track width direction, the Y direction is the height direction (the direction that a magnetic field leaks from a recording medium M), and the Z direction is the moving direction of the recording medium M.

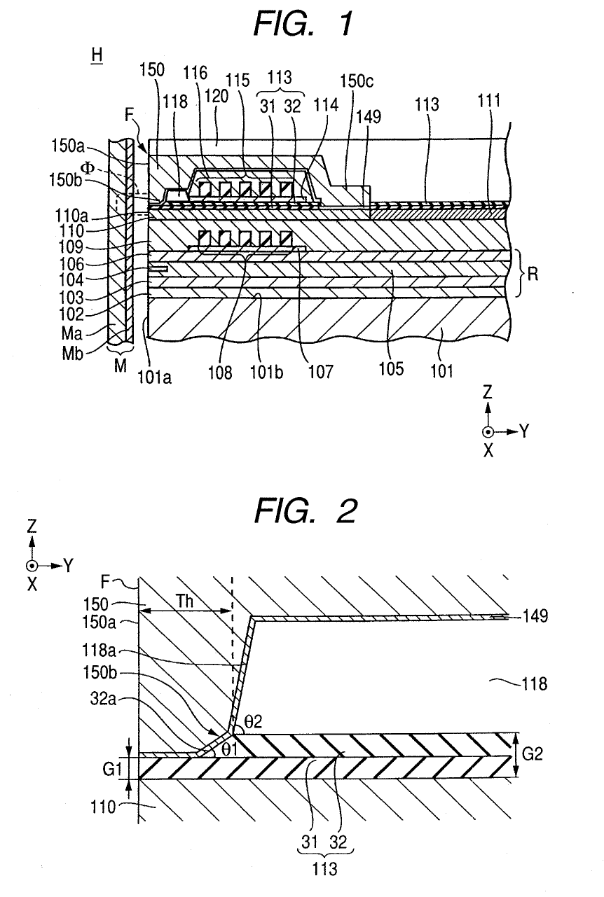

FIG. 1 is a partly longitudinal sectional view showing the entire structure of a perpendicular magnetic recording head H according to a first embodiment of the present disclosure. FIG. 2 is a partly enlarged sectional view showing a circumferential portion of a return yoke layer of the perpendicular magnetic recording head H.

In the perpendicular magnetic recording head H, a perpendicular magnetic field is applied to a recording medium M to thereby magnetize a hard film Ma of the recording medium M in the perpendicular direction. The recording medium M includes the hard film Ma with a higher residual magnetization at the surface side and a soft film Mb with a higher magnetic permeability at the inner side of the hard film Ma. The recording medium M is, for example, disk-shaped and is rotated about the center of the disk, which serves as the axis of rotation.

A slider 101 is composed of a nonmagnetic material such as Al₂O₃ or TiC. A medium-opposing surface 101a of the slider 101 opposes the recording medium M. As the recording medium M is rotated, the slider 101 floats up from the surface of the recording medium M by the airflow on the surface. A nonmagnetic insulating layer 102 composed of an inorganic material such as Al₂O₃ or SiO₂ is formed on a trailing side-end surface 101b of the slider 101. A read section R is formed on the nonmagnetic insulating layer 102. The read section R includes a lower shield layer 103, an upper shield layer 106, an inorganic insulating layer (gap insulating layer) 105 that fills the space between the lower shield layer 103 and the inorganic insulating layer 106, and a read element 104 located in the inorganic insulating layer 105. The read element 104 is a magnetoresistive (MR) element such as AMR (anisotropic MR), GMR (giant MR), and TMR (tunneling MR).

A plurality of first coil layers 108 made of a conductive material is formed on a coil insulating underlayer 107 on the upper shield layer 106. The first coil layers 108 are each formed, for example, of at least one or two non-magnetic metal materials selected from the group consisting of Au, Ag, Pt, Cu, Cr, Al, Ti, NiP, Mo, Pd, and Rh. Alternatively, a laminate structure composed of the non-magnetic metal materials mentioned above may be formed. A coil insulating layer 109 made of an inorganic insulating material such as Al₂O₃ or an organic insulating material such as a resist is formed around the first coil layers 108.

An upper surface of the coil insulating layer 109 is flattened, and a plated underlayer (not shown) is formed on the flattened surface. A main magnetic pole layer 110 is formed on the plated underlayer. The main magnetic pole layer 110 is formed, for example, of a ferromagnetic material having a high saturation magnetic flux density such as Ni—Fe, Co—Fe, or Ni—Fe—Co. The main magnetic pole layer 110 has a front end surface 110a exposed to an opposing surface F opposite the recording medium (this surface will be referred to as a medium opposing surface F). The dimension of the front end surface 110a in the track width direction is defined as a track width. A first insulating material layer 111 is formed at both sides of the main magnetic pole layer 110 in the track width direction and the rear side in the height direction. The first insulating material layer 111 may be formed, for example, of Al₂O₃, SiO₂, and Al—Si—O.

A magnetic gap layer 113 made of an nonmagnetic material is formed on the main magnetic pole layer 110 and the first insulating material layer 111. As shown in FIG. 2, the magnetic gap layer 113 includes an Al₂O₃ film 31 (a nonmagnetic material film) exposed to the recording medium-opposing surface F and disposed between the main magnetic pole layer 110 and the return yoke layer 150 at the recording medium-opposing surface F and a Ti film 32 not exposed to the recording medium-opposing surface F and disposed right below the resist layer 118 at a side deeper than the recording medium-opposing surface F in the height direction. In other words, the magnetic gap layer 113 has a single structure composed of the Al₂O₃ film 31 on the recording medium-opposing surface F side, and has a two-layer structure composed of the Al₂O₃ film 31 and the Ti film 32 on the deeper side in the height direction.

The Al₂O₃ film 31 is formed on the main magnetic pole layer 110 and the first insulating material layer 111. The film thickness defines a gap spacing G1 in the recording medium-opposing surface F. In the embodiment shown in FIG. 2, the gap spacing G1 is about 30 nm to 70 nm. The Al₂O₃ film 31 has properties that it is weak (i.e., easy to erode) in an alkali solution.

The Ti film 32 is a non-light transmitting layer and is not eroded in an alkali solution. The Ti film 32 covers the Al₂O₃ film 31 from the position retreated from the recording medium-opposing surface F in the height direction by a predetermined distance. The front end surface 32a of the Ti film 32 close to the recording medium-opposing surface F forms an inclined surface of which the film thickness increases as the front end surface extends in the height direction. The rise angle of the inclined surface is set to an angle θ1. The thickness of the Ti film 32 is about 30 Å to about 500 Å. The film thickness (a gap spacing G2) of the magnetic gap layer 113 on the deeper side in the height direction corresponds to the sum of the thicknesses of the Ti film 32 and the Al₂O₃ film 31. The gap spacing G2 is greater than the film thickness (the gap spacing G1) of the magnetic gap layer 113 in the recording medium-opposing surface F (G1<G2).

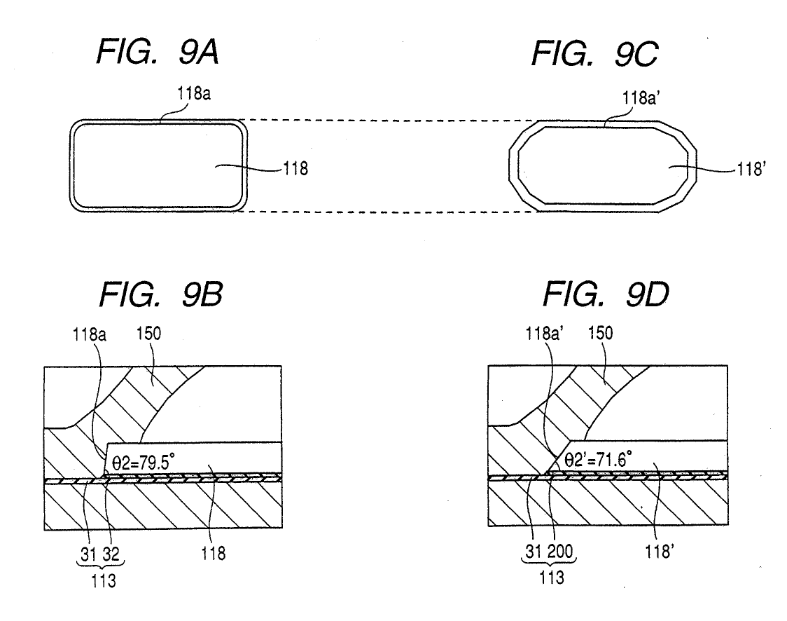

A resist layer 118 that determines a throat height Th of the perpendicular magnetic recording head H by the distance (dimension in the height direction) from the recording medium-opposing surface F to a front end surface 118a disposed at a position retreated from the recording medium-opposing surface F to the deeper side in the height direction by a desired throat height Th. The resist layer 118 is made of an organic resist material and has good cohesive properties with respect to the Ti film 32. As shown in FIG. 9A, the resist layer 118 has a rectangular shape in top view. As shown in FIG. 9B, the front end surface 118a of the resist layer 118 forms an inclined surface of which the film thickness increases as the front end surface 118a extends in the height direction. The rising angle of the inclined surface is set to an angle θ2 (0 degrees<θ2≦90 degrees). Since the film thickness of the front end surface 118a is large as the rising angle θ2 increases, the front end surface 118a can be formed with little positional error, which may otherwise be caused due to the uneven etching during a forming step. Therefore, the positional precision of the throat height Th is improved. The rising angle θ2 of the resist layer 118 is different from the rising angle θ1 of the Ti film 32.

A second coil layer 115 is formed on a coil insulating underlayer 114 on the Ti film 32 at a position deeper than the resist layer 118 in the height direction. A plurality of the second coil layer 115 is formed of a conductive material, similar to the first coil layer 108. The second coil layers 115 are each formed, for example, of at least one or two non-magnetic metal materials selected from the group consisting of Au, Ag, Pt, Cu, Cr, Al, Ti, NiP, Mo, Pd, and Rh. Alternatively, a laminate structure composed of the non-magnetic metal materials mentioned above may be formed. The first coil layers 108 and the second coil layers 115 have their respective ends in the track width direction (in the X direction in the drawing) electrically connected to each other such that they form a solenoid. The shape of the coil layers 108 and 115 (magnetic field generating means) are not limited to the solenoid.

A coil insulating layer 116 is formed around the second coil layers 115.

A plated underlayer film 149 is formed over the front end surface 32a of the Ti film 32, the resist layer 118, and the coil insulating layer 116 from the Al₂O₃ film 31 close to the recording medium-opposing surface F (a region not covered with the Ti film 32). A return yoke layer 150 is formed on the plated underlayer film 149 by plating with a ferromagnetic material having a high saturation magnetic flux density such as Ni—Fe, Co—Fe, or Ni—Fe—Co. The return yoke layer 150 has a front end surface 150a exposed to the recording medium-opposing surface F and opposes the main magnetic pole layer 110 at this front end surface 150a with a gap spacing G1. The return yoke layer 150 includes a connecting part 150c that is magnetically coupled to the main magnetic pole layer at a deeper side in the height direction and a throat part 150b that is connected to the front end surface 32a of the Ti film 32 and the front end surface 118a of the resist layer 118. As described above, the rising angle θ1 of the front end surface 32a of the Ti film 32 is different from the rising angle θ2 of the front end surface 118a of the resist layer 118. The throat part 150b therefore has a two-stepped throat shape in which the inclination changes at the boundary of the Ti film 32 and the resist layer 118. As a result of using the two-stepped throat shape, by setting the gap spacing G1 at the recording medium-opposing surface F side small, it is possible to prevent divergence of a magnetic flux oriented toward the recording medium M from the main magnetic pole layer 110. Thus, the recording magnetic field gradient characteristics can be improved. At the same time, by setting the gap spacing G2 at the deeper side in the height direction, even when the maximum dimension of the return yoke layer 150 in the height direction is increased as much as possible, it is not necessary to prevent divergence of a magnetic flux oriented toward the recording medium M from the main magnetic pole layer 110. Thus, high recording magnetic field intensity can be maintained.

In a much deeper side than the connecting part 150c of the return yoke layer 150 in the height direction, a lead layer (not shown) extending from the second coil layer 115 is formed through the coil insulating underlayer 114. The return yoke layer 150 is covered with a protective layer 120 formed of an inorganic non-magnetic insulating material or the like.

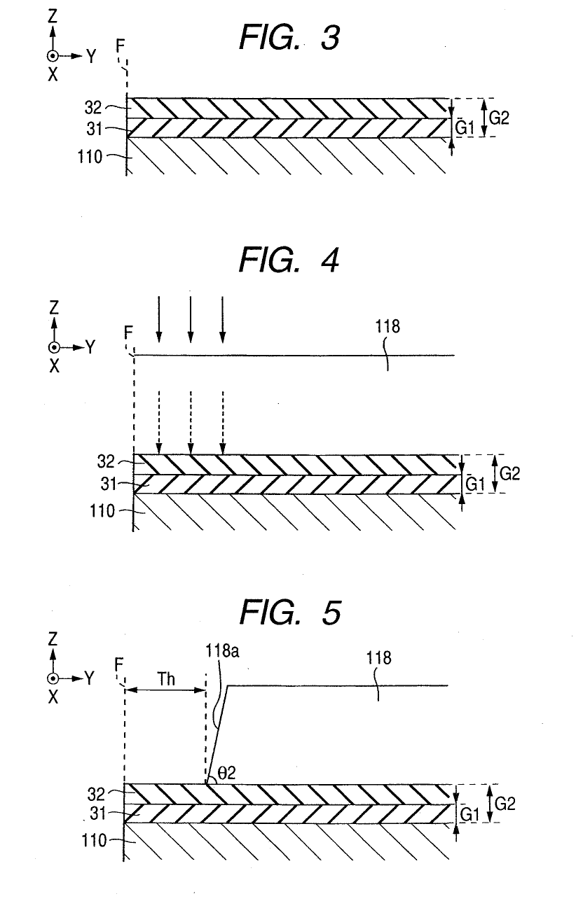

Next, a manufacturing method of the perpendicular magnetic recording head of the present disclosure will be described with reference to FIGS. 3 to 6. The method of the present disclosure is characterized in the forming step of the front end portion (especially, the magnetic gap layer 113, the resist layer 118, and the return yoke layer 150) of the perpendicular magnetic recording head. Therefore, hereinafter, the step of forming the front end portion of the perpendicular magnetic recording head will be described in detail.

First, the non-magnetic insulating layer 102, the main magnetic pole layer 110, and the first insulating material layer 111 are formed at a trailing side end surface 101b of the slider 101 in accordance with process steps well known in the art.

Next, as shown in FIG. 3, an Al₂O₃ film 31 is uniformly formed on the main magnetic pole layer 110 and the first insulating material layer 111 so as to have a thickness equal to a desired gap spacing G1 in the recording medium-opposing surface F. In this state, it is practical that the film thickness (gap spacing G1) of the Al₂O₃ film 31 is about 30 nm to about 70 nm. A sputter method or vapor deposition method is used in forming the Al₂O₃ film 31.

Subsequently, as shown in FIG. 3, a Ti film 32 is formed on the entire surface of the Al₂O₃ film 31. The Ti film 32 is a nonmagnetic material film that is not eroded in an alkali solution and is a non-light transmitting film. The Ti film 32 is formed to a film thickness of about 30 Å to about 500 Å. The total thickness of the Al₂O₃ film 31 and the Ti film 32 defines a gap spacing G2 at the deeper side in the height direction. The Ti film 32 functions as a protective layer for preventing the Al₂O₃ film 31 from being damaged by etching during the manufacturing processes. Like the Al₂O₃ film 31, a sputter method or vapor deposition method is used in forming the Ti film 32.

Subsequently, as shown in FIGS. 4 and 5, a resist layer 118 defining a throat height Th is formed by a photolithographic process (exposure, development, and post-bake).

During the photolithographic process, as shown in FIG. 4, a resist layer 118 made of an organic resist material is formed on the entire surface of the Ti film 32.

Next, as shown in FIG. 4, the resist layer 118 is exposed and a pattern corresponding to a resist shape to be formed is transferred thereto. In this embodiment, the resist layer 118 is patterned in a rectangular shape (FIG. 9A). At this time, light irradiated from above the resist layer 118 having a photomask (not shown) placed thereon and having passed through the resist layer 118 is blocked by the Ti film 32 disposed right below the resist layer 118 and cannot travel further deeper than the Ti film 32. Therefore, even when a metal film (the main magnetic pole layer 110) with high reflectivity is formed below the Ti film 32, reflection light is not generated from the metal film. Thus, irregular reflection by the reflection light is not caused. In such a state that there is no irregular reflection, it is easy to perform focusing during resist exposure. It is possible to ensure sufficient contrast in the circumferential portion of the resist shape to be formed, thereby improving the patterning precision. The arrows in FIG. 4 represent light irradiated during resist exposure.

After the resist exposure is completed, a developing process is performed using an alkali development solution. Although the Al₂O₃ film 31 has properties that it is weak in the alkali solution, since the film 31 is covered with the Ti film 32 that is not eroded in the alkali solution and is not exposed to the outside, the Al₂O₃ film 31 is not eroded by the alkali solution. Thus, it is possible to maintain the thickness of the Al₂O₃ 31 at the time of filming forming.

As a result of the above process steps, only the resist layer 118 remains on the Ti film 32 in such a pattern shape that the front end surface 118a is disposed at a position retreated from the recording medium-opposing surface F to the deeper side in the height direction by a desired throat height Th. In the resist layer 118 remaining on the Ti film 32, as described above, since sufficient edge contrast is ensured during the resist exposure, there are no faults or scum in the circumferential portion of the resist layer 118. The resist layer 118 is formed in a desired shape, position and dimension, as desired in the resist exposure. The throat height Th defined by the resist layer 118 is about 50 nm to about 400 nm.

After the developing process, the resist layer 118 is post-baked. At this time, by controlling a post-bake temperature, the resist layer 118 is formed at an inclined surface having a rising angle θ2 (0 degrees<θ2≦90 degrees) so that the film thickness of the resist layer 118 is increased to that of the deeper side in the height direction.

After the resist layer 118 is formed by the photolithographic process, a second coil layer 115 is formed on a coil insulating underlayer 114 on the Ti film 32 at a deeper side than the resist layer 118 in the height direction. A coil insulating layer 116 is formed on the entire surface of the second coil layer 115. The coil insulating layer 116 is formed of a resist or the like.

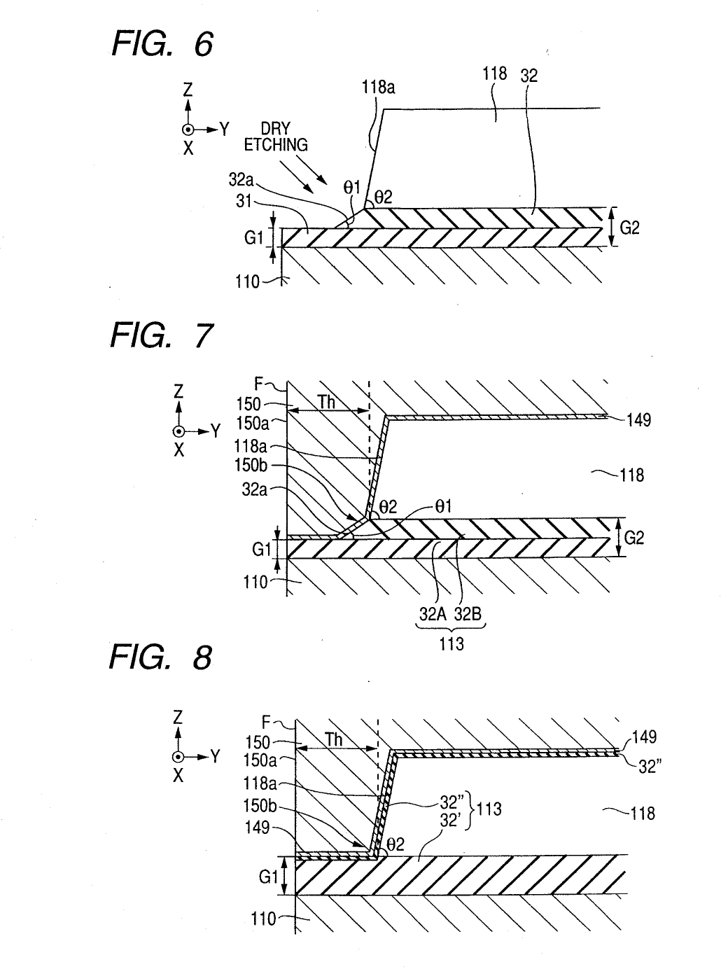

Subsequently, a dry etching process such as milling is performed as a plating pre-treatment of a return yoke layer to be formed in a subsequent process step. In the dry etching process, as shown in FIG. 6, the surfaces of the resist layer 118 and the coil insulating layer 116 are cut to remove a surface oxidation layer so that a new film surface is exposed. At the same time, the Ti film 32 not covered with the resist layer 118 is removed so that the Al₂O₃ film 31 is exposed to the removed portion. In other words, the dry etching process is continued until the Al₂O₃ film 31 is exposed to the end surface serving as the recording medium-opposing surface F. Once the Al₂O₃ film 31 is exposed, the dry etching process is finished. Since the etching rate of the Al₂O₃ film 31 is lower than the etching rate of the Ti film 32, it is easy to detect whether the Al₂O₃ film 31 is exposed or not. It is also possible to control the etching end time with high precision. In this way, the film thickness at the time of forming the Al₂O₃ film 31 exposed to the recording medium-opposing surface F is favorably maintained.

In the dry etching process, the etching rate is regulated such that a front end surface 32a of the Ti film 32 is formed at an inclined surface having a rising angle θ1 (0 degrees<θ1<85 degrees) so that the film thickness of the Ti film 32 increases to that of the deeper side in the height direction. The rising angle θ1 of the Ti film 32 is designed so as to differ from the rising angle θ2 of the resist layer 118.

By the dry etching process, a magnetic gap layer 113 is obtained in which a single-layer structure of the Al₂O₃ film 31 is formed from the end surface serving as the recording medium-opposing surface F to the vicinity of the throat height Th position, and in which a two-layer structure of the Al₂O₃ film 31 and the Ti film 32 is formed at the deeper side in the height direction than the throat height Th position. At a region deeper in the height direction than the throat height Th position, i.e., a region in which the second coil layer 115 is formed, the thickness of the magnetic gap layer 113 is larger than that of a region where the magnetic gap layer is formed only of the Al₂O₃ film 31. Thus, it is possible to improve insulating properties between the second coil layer 115 and the main magnetic pole layer 110.

Subsequently, a plated underlayer film 149 is formed over the Al₂O₃ film 31 exposed to the end surface serving as the recording medium-opposing surface F, the front end surface 32a of the Ti film 32, the resist layer 118, and the coil insulating layer 116. A return yoke layer 150 is formed on the plated underlayer film 149 by plating. In this way, the throat height Th of the return yoke layer 150 is defined by the dimension in the high direction from the position serving as the recording medium-opposing surface F to the front end surface 118a of the resist layer 118. As described above, since the resist layer 118 is formed with high patterning precision, the precision of the throat height Th defined by the resist layer 118 is also improved. The front end surface 32a of the Ti film 32 and the front end surface 118a of the resist layer 118 are inclined surfaces having the rising angles θ1 and θ2, respectively, and the rising angles θ1 and θ2 are different from each other. Therefore, as shown in FIG. 2, a two-stepped throat part 150b of which the inclination changes at the boundary of the Ti film 32 and the resist layer 118 is formed on the return yoke layer 150. When the throat shape of the return yoke layer 150 is formed to have two steps, a gap spacing at the deeper side in the height direction than the recording medium-opposing surface F can be increased in a narrow region that extends from the end surface serving as the recording medium-opposing surface F to the throat height position. Therefore, even when a large throat height Th is defined, recording magnetic field intensity can be favorably maintained. Thus, it is possible to control the recording resolution (recording magnetic field gradient) and the write performance (recording magnetic field intensity) in a harmonized fashion. The magnitude relationship between the rising angles θ1 and θ2 of the Ti film 32 and the resist layer 118 is appropriately set in accordance with the desired recording resolution and the desired write performance.

After the return yoke layer 150 is formed, a lead layer (not shown) is formed at a deeper side in the height direction than the return yoke layer 150. A protective layer 120 is formed to cover the lead layer and the return yoke layer 150.

The recording medium-opposing surface F is formed by machining (ABS processing) on the end surface serving as the recording medium-opposing surface F. In the recording medium-opposing surface F, the Al₂O₃ film 31 is exposed between the main magnetic pole layer 110 and the return yoke layer 150. The main magnetic pole layer 110 opposes the return yoke layer 150 with a gap spacing G1 equal to the film thickness of the Al₂O₃ film 31.

In this way, the perpendicular magnetic recording head H shown in FIGS. 1 and 2 is obtained.

According to the first embodiment described above, after the resist layer 118 is formed on the Ti film 32, which is a non-light transmitting film, the exposure and developing process is performed. By the Ti film 32, the irregular reflection during the resist exposure is prevented, making it easy to control focusing and improving the edge contrast of a resist pattern to be formed. With this, the patterning (shape, position and dimension) precision of the resist layer 118 is improved and the perpendicularity (the rising angle θ2) of the front end surface 118a of the resist layer 118 is increased. As a result of using the resist layer 118 excellent in the patterning precision and the perpendicularity of the front end surface 118a, it is possible to define the throat height Th with high precision. Therefore, even when a metal film (the main magnetic pole layer 110, for example) with high reflectivity is formed below the Ti film 32, since light cannot pass through the layer below the Ti film 32, reflection light is not generated from the metal film. Thus, the shape of the metal film can be designed with a high degree of freedom.

According to the first embodiment described above, since the cohesive properties between the Ti film 32 and the resist layer 118 are excellent, it is not necessary to perform the HMDS process for improving the cohesive properties with respect to the resist layer 118. The generation of scum is eliminated. Moreover, an etching process for removing the scum is not required. Therefore, the throat height Th becomes constant, which otherwise be caused by an uneven etching.

According to the first embodiment described above, since the Ti film 32 has properties that it is not eroded in the alkali development solution, the Ti film 32 serves as a protective film of the Al₂O₃ film 31. The etching resistance of the magnetic gap layer 113 to the alkali development solution is improved. Thus, it is possible to prevent fluctuation of the gap spacing G1 in the recording medium-opposing surface F.

In the first embodiment, although the magnetic gap layer 113 is formed using the Al₂O₃ film 31 and the Ti film 32, the magnetic gap layer 113 may be only of the Ti film 32.

In the case of forming the magnetic gap layer 113 using only the Ti film, as shown in FIG. 7, the Al₂O₃ film 31 of the first embodiment is replaced with the Ti film 32 composed of a lower Ti film 32A and an upper Ti film 32B. Alternatively, as shown in FIG. 8, the Ti film 32 may be composed of a Ti film 32′ and a second Ti film 32″. In this case, the Ti film 32′ is formed on the main magnetic pole layer 110 so as to have a film thickness corresponding to the gap spacing G1. A resist layer is formed on the entire surface of the Ti film 32′. After this, in a manner similar to the case of the first embodiment, a resist layer 118 is formed to define the throat height Th using a photolithographic process (exposure, development, and post-bake). After forming the resist layer 118, a dry etching process is performed on the entire surface to expose the resist layer 118 and a new film surface of the Ti film 32′ not covered with the resist layer 118. Subsequently, the second Ti film 32″ is formed on the entire surface of the exposed Ti film 32′ and the resist layer 118. At this time, the second Ti film 32″ is formed until the total film thickness of the Ti film 32′ and the second Ti film 32″ becomes a desired gap spacing G1 in the recording medium-opposing surface. A plated underlayer film 149 is formed on the second Ti film 32″, and a return yoke layer 150 is formed on the plated underlayer film 149 by plating. By forming the second Ti film 32″ and the plated underlayer film 149 in the same vacuum device, it is possible to form the plated underlayer film 149 on the second Ti film 32″ with good cohesive properties. In this way, even when the magnetic gap layer 113 is formed only of the Ti film, since the Ti film is present right below the resist layer 118, it is possible to provide the same advantage as the first embodiment.

When the magnetic gap layer 113 is formed only of the Ti film, the Ti film is exposed to the recording medium-opposing surface F. The amount of the Ti film processed by a polishing processing for forming the recording medium-opposing surface F is substantially the same as the processing amount of NiFe, which is a material of the main magnetic pole layer 110 or the return yoke layer 150. Therefore, there is little possibility of a recess to be formed in the recording medium-opposing surface F.

FIGS. 9A and 9B are top and sectional views, respectively, schematically showing a patterned resist layer 118 (Inventive Example) when a Ti film 32 is formed right below the resist layer 118 as at least a part of the magnetic gap layer 113. FIGS. 9C and 9D are top and sectional views, respectively, schematically showing a patterned resist layer 118 (Comparative Example) when a SiO₂ film 200 is formed right below a resist layer 118′ as at least a part of the magnetic gap layer 113.

The resist layer 118 of Inventive Example and the resist layer 118′ of Comparative Example are patterned to be able to obtain the same rectangular shape.

As shown in FIG. 9A, in Inventive Example, the resist layer 118 is formed in a desired rectangular shape. It is obvious that there are no faults or scum in the circumferential portion. As shown in FIG. 9B, the front end surface 118a of the resist layer 118 is formed in an inclined surface of which the film thickness increases as it goes deeper in the height direction. The rising angle θ2 was about 79.5 degrees.

On the other hand, in Comparative Example, as shown in FIG. 9C, there are faults in the circumferential portion of the resist layer 118′. It is obvious that the position of the front end surface 118a′ for defining the throat height fluctuates. As shown in FIG. 9D, the front end surface 118a′ of the resist layer 118′ is formed in an inclined surface of which the film thickness increases as it goes deeper in the height direction. However, the rising angle θ2′ was about 71.6 degrees.

As is obvious from FIG. 9, in the case of Inventive Example in which the Ti film is present right below the resist layer, compared with the case of Comparative Example in which the SiO₂ film is present right below the resist layer, the patterning precision (shape, position and dimension) of the resist layer is improved. Thus, it is possible to increase the perpendicularity (the rising angle θ2) of the front end surface. Consequently, by using the resist layer excellent in the patterning precision and the perpendicularity of the front end surface, it is possible to define the throat height Th with high precision.

The terms and descriptions used herein are set forth by way of illustration only and are not meant as limitations. Those skilled in the art will recognize that many variations can be made to the details of the above-described embodiments without departing from the underlying principles of the disclosure. The scope of the disclosure should therefore be determined only by the following claims (and their equivalents) in which all terms are to be understood in their broadest reasonable sense unless otherwise indicated.

What is claimed is:

1. A perpendicular magnetic recording head, comprising:
a main magnetic pole layer;
a return yoke layer laminated on the main magnetic pole layer with a magnetic gap layer disposed in an opposing surface opposite a recording medium; and
a resist layer having a front end surface at a position retreated from the opposing surface opposite the recording medium to a deeper side in a height direction, the resist layer defining a throat height of the return yoke layer at the front end surface position,
wherein a Ti film is formed directly below the resist layer, forming at least a portion of the magnetic gap layer, the Ti film being a non-light transmitting film through which light cannot pass.

2. The perpendicular magnetic recording head according to claim 1, wherein the magnetic gap layer is formed by laminating a nonmagnetic material film that is not exposed to the opposing surface opposite the recording medium, on a side deeper in the height direction than the opposing surface opposite the recording medium, the nonmagnetic material layer being exposed to the Ti film disposed directly below the resist layer and the opposing surface opposite the recording medium, the nonmagnetic material layer being disposed in the opposing surface opposite the recording medium between the main magnetic pole layer and the return yoke layer.

3. The perpendicular magnetic recording head according to claim 2, wherein the nonmagnetic material film comprises Al₂O₃.

4. A manufacturing method of a perpendicular magnetic recording head, comprising:
forming a nonmagnetic material film on a main magnetic pole layer to form a portion of a magnetic gap layer;
forming a Ti film on the nonmagnetic material film to form a portion of the magnetic gap layer, the Ti film being a non-light transmitting layer through which light cannot pass;
forming a resist layer of an organic resist material on the entire surface of the Ti film;
exposing and developing the resist layer while leaving the resist layer on the Ti film in such a pattern shape that a front end surface of the resist layer is retreated from a position serving as an opposing surface opposite a recording medium to a deeper side in the height direction by a predetermined throat height;
performing a dry etching process to expose a new film surface of the resist layer while removing the Ti film not covered with the resist layer to expose the nonmagnetic material film to the removed portion; and
forming a return yoke layer on the exposed nonmagnetic material film, Ti film, and resist layer.

5. The manufacturing method of the perpendicular magnetic recording head according to claim 4, wherein the nonmagnetic material film comprises Al₂O₃.

6. A manufacturing method of a perpendicular magnetic recording head, comprising:
forming a Ti film on a main magnetic pole layer to constitute a magnetic gap layer, the Ti film being a non-light transmitting film through which light cannot pass;
forming a resist layer of an organic resist material on the entire surface of the Ti film;
exposing and developing the resist layer while leaving the resist layer on the Ti film in such a pattern shape that a front end surface of the resist layer is retreated from a position serving as an opposing surface opposite a recording medium to a deeper side in the height direction by a predetermined throat height;
performing a dry etching process to expose the resist layer and a new film surface of the Ti film not covered with the resist layer;
forming a second Ti film on the entire surface of the exposed resist layer and Ti film; and
forming a return yoke layer on the second Ti film by plating.
